(19) United States
(12) Patent Application Publication
(10) Pub. No.: US 2023/0079477 A1
(43) Pub. Date: Mar. 16, 2023

(54) METHODS FOR OPTIMIZED EXTRUDER STARTUP

(71) Applicant: ExxonMobil Chemical Patents Inc., Baytown, TX (US)

(72) Inventors: Bobi A. SIMONSEN, Houston, TX (US); Andrew J. REICH, Gibsonia, PA (US); Kevin J. LEONARD, Friendswood, TX (US); Yik Meng CHIA, Kuala Lumpur (MY); Nathaniel B. GUY, Sewickely, PA (US)

(21) Appl. No.: 18/047,549

(22) Filed: Oct. 18, 2022

Related U.S. Application Data
(60) Provisional application No. 63/263,342, filed on Nov. 1, 2021.

(51) Int. Cl. B29C 48/92; B29C 48/285

(52) U.S. Cl. CPC B29C 48/92; B29C 48/286; B29C 48/288; B29C 2948/922; B29C 2948/92828; B29C 2948/926

(57) ABSTRACT

Methods for startup of an extruder include (a) initiating feed of a polymer resin to the extruder using a volumetric feeder such that, where the melt index of the polymer resin is less than 10 g/10 min (ASTM D1238 at 230° C., 2.16 kg), the volumetric feeder is operated at a first volumetric feeder speed; or (b) initiating feed of a polymer resin to the extruder using the volumetric feeder such that, where the melt index of the polymer resin is 10 g/10 min or greater, the volumetric feeder is operated at a second volumetric feeder speed greater than the first. The first volumetric feeder speed can range from about 20% to about 25% of the volumetric feeder max speed; and the second volumetric feeder speed can range from about 30% to about 35% of the volumetric feeder max speed.

### CROSS-REFERENCE TO RELATED APPLICATION

This application claims the benefit of U.S. Provisional Application 63/263,342 filed Nov. 1, 2021, entitled “Methods for Optimized Extruder Startup”, the entirety of which is incorporated herein by reference.

### FIELD OF THE INVENTION

The presently disclosed subject matter relates to improved extruder startup processes that minimize extruder shutdown and failure by optimizing feeder rates based on melt index.

### BACKGROUND OF THE INVENTION

In polymer extrusion systems, a polymer may be converted to a molten state and forced through an extrusion die or die plate at high pressure, where the die plate has several (e.g., dozens, hundreds, thousands, etc.) of flow channels ending in small orifices (e.g., approximately 3 mm) that shape the molten polymer. As the polymer product exits the die plate, it contacts a cooling medium (usually water) and begins to solidify. Extrusion systems may also be equipped with a pelletizer that includes an array of rotating blades that cut the polymer exiting the die into small pellets. Pelletized polymer may then be carried by process water flowing across the die face to a centrifugal dryer where water is removed and dry pellets are discharged.

Prior to reaching steady state production of polymer, extrusion initiation (or “startup”) can involve ramping up feeders to direct polymer material (pellets, granules, flakes, or powders) into the barrel of the extruder. The polymer is gradually melted as it is processed by turning screws and heaters within the barrel, and shaped through a die as it exits the extruder. Once flow through the extruder die is achieved, the speed of the feeders and extruder are slowly ramped up until reaching the final operating conditions (“steady state”). Efficient extruder startup and rapid transition to steady state is desirable, because polymer generated during this phase is off specification and represents material loss.

Startup failures may also occur prior to entering steady state for a number of reasons, including operating pressures that are too high or low, improper temperatures within the extruder barrel, improper feed rates, and the like. Issues during startup can trigger limit alarms that shutdown the extruder before safety issues or equipment damage occur. Following extruder shutdown, any damage must be mitigated, polymer waste must be removed from the extruder barrel, and the extruder must be reset prior to re-attempting startup. While methods of resetting an extruder after a failed startup can vary, all can result in economic impact associated with material costs and lost production time.

Reference of potential interest in this regard include: U.S. Pat. Nos. 10,794,512; 9,926,390; 6,720,393; WO1992-15858; WO2017-170675.

### SUMMARY OF THE INVENTION

The present invention is directed to improved extruder startup processes that minimize extruder shutdown and failure by optimizing feeder rates based on melt index.

In an aspect, methods for startup of an extruder include (a) initiating feed of a polymer resin to the extruder using a volumetric feeder; and (b−1) where the melt index of the polymer resin (ASTM D1238 at 230° C., 2.16 kg) is less than 10 g/10, operating the volumetric feeder at a first initial speed (which can, for example, range from about 20% to about 25% of the volumetric feeder max speed); or (b−2) where the melt index of the polymer resin is 10 g/10 min or greater, initiating feed of the polymer resin to the extruder using the volumetric feeder operating at a second initial speed that is higher than the first initial speed (e.g., a speed ranging from about 30% to about 35% of the volumetric feeder max speed).

In another aspect, methods for startup of an extruder following a startup failure may include determining a melt index according to ASTM D1238 at 230° C. with 2.16 kg load for a polymer resin and a volumetric feeder speed used during the startup failure; and keeping the polymer resin constant and modifying the volumetric feeder speed by at least 5% of the volumetric feeder max speed; or keeping the volumetric feeder speed constant and modifying the polymer resin (and in particular, modifying the polymer resin from a first polymer resin having a first melt index to a second polymer resin having a second melt index).

In yet further aspects, methods can include obtaining a polymer resin, feeding the resin to an extruder via a volumetric feeder, and calibrating the speed at which the volumetric feeder provides the resin to the extruder during initiation of the extrusion of the polymer resin at a desired mass flow rate, the calibrated feeder speed being based at least in part upon the melt index of the polymer resin. The calibrated feeder speed can be

### BRIEF DESCRIPTION OF THE DRAWINGS

FIG. 1 is a schematic diagram showing an extruder system in accordance with the present disclosure.

FIG. 2 is a flow diagram illustrating a method of optimizing extruder startup in accordance with the present disclosure.

FIG. 3 is a graphical representation of rotary feeder speed as a function of time for a series of successful extruder startups.

FIG. 4 is a graphical representation of rotary feeder speed as a function of time for a series of unsuccessful extruder startups.

### DETAILED DESCRIPTION OF THE INVENTION

Methods disclosed herein include improved extruder startup processes that minimize extruder shutdown and failure. Particularly, methods disclosed herein include optimizing extruder startup by optimizing feeder rates based on melt index (MI), including for high MI polymers. Methods also include operating modifications to prevent subsequent shutdowns following an unsuccessful startup and reactor shutdown.

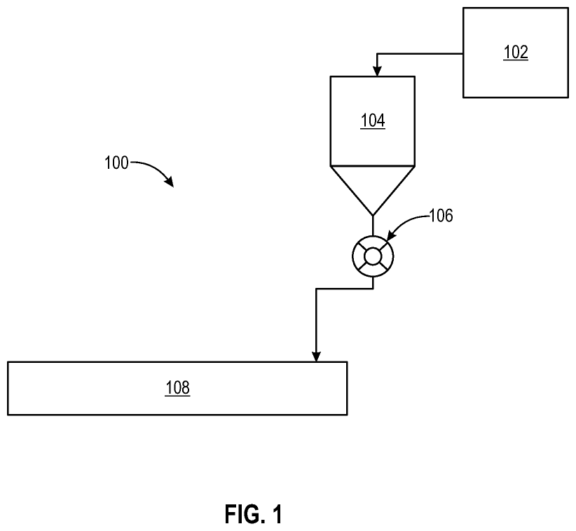

A common extruder system 100 for extruding a polymer resin (e.g., polyethylene, polypropylene) extrusion is shown in FIG. 1. Polymer resin from a reactor 102 or other suitable source is stored in a feedbin 104 or other vessel prior to processing. Polymer resin may be of any suitable form based on the feeder type, including solids, granular powders, melts and liquids. During operation, polymer resin feed is directed by a volumetric feeder 106 from the feedbin 104 to extruder 108. Volumetric feeder 106 (or equivalent feeder) controls the throughput of polymer resin using a variable speed drive (e.g., screw, rotor, etc.) that can increase or decrease feed rate of the polymer resin based on extruder system 100 demand. Throughput of polymer resin by the volumetric feeder 106 controls the feed rate of resin into the extruder 108 and, in effect, also serves as a control over the pressure within the extruder 108 barrel. Volumetric feeder 106 may operate by differing mechanisms and include rotary feeders, screw feeders, vibratory feeders, belted feeders, and the like.

Pressure within extruder 108 is also a function of polymer resin properties, such as density, molecular weight, degree of crosslinking, and the like. As used herein, polymer properties are characterized by bulk measurement in terms of melt index (MI), which is determined according to ASTM D1238-13 at 230° C. with 2.16 kg load, unless otherwise noted. In general, the higher the MI of a polymer (an MI greater than or equal to 10 g/10 min, for example), the less viscous the polymer resin and the higher feed rates that are required to maintain pressure in the extruder 108.

During extruder startup, operating conditions are controlled in large part by the polymer resin type (often characterized as density or grade) and the flux of the polymer resin through the extruder system 100. The flux through the extruder 108 is dependent in part on the operating speed of the extruder 108 and the volumetric feeders 106 metering the polymer resins and other additives. Because of the correlation between polymer resin feed rate and operating pressure, proper selection of feeder 106 speed is a critical element to prevent unplanned extruder 108 shutdowns. Once molten polymer exits the extruder 108 die, and depending on the pressure and melt flow limits, the extruder 108 screw speed is increased, followed by increased feed rates from feeder 106 until the extrusion system reaches a steady state of production. Once the extruder reaches steady state, extruder 108 and feeder 106 speeds may remain constant depending on the nature of the polymer product and other constraints.

Startup failure is often due to a mismatch of the feeder 106 speed with the polymer resin grade, which can generate large amounts of polymer waste and can incur costs associated with production downtime. Mismatch between feeder 106 speed and polymer resin grade can occur in practice by running different polymer grades (higher or lower MI) at a prior speed setting for a prior MI polymer, or applying inconsistent feeder 106 speeds between production runs of the same polymer grade.

Proper startup largely relies on balancing the polymer resin feed rates of feeder 106 to maintain the pressure within the extruder system 100 at acceptable levels to avoid triggering alarm limits that automatically shutdown the extruder 108 to avoid unsafe conditions. At low feeder speeds the extruder pressure may be insufficient to drive the resin through the extruder 108, leading to shutdown. On the other hand, feed rates that are too high can cause feeding issues and excessive pressure within the extruder, which can trigger high pressure alarms and shutdown.

Methods disclosed herein optimize and automate extruder volumetric feeder (e.g., rotary feeder) start-up speeds based on the polymer resin melt index; this, in turn, reduces failed extruder startups. Methods also include general guidelines as to the selection of starting volumetric feeder speeds, and a methodology to reduce startup failures by matching polymer resin feed rates with the polymer resin grade and/or modifying the observed MI of the polymer resin. Volumetric feeder speeds are described herein as % of maximum volumetric feeder speed in view of the critical maximum feeder speed beyond which volumetric throughput of the resin actually decreases even for increasing feeder speed. For example, in the case of a rotary feeder, a critical maximum rpm (rotations per minute) of the rotary feeder exists beyond which mass throughput of polymer resin through the feeder would actually decrease for increasing RPM of the rotary feeder. This critical maximum speed can typically be on the order of 5 or 10 rpm to 20, 25, or 30 rpm; but it can vary with different designs of feeders (e.g., different rotary feeders), and because the present methods can be employed without regard to the specific feeder design, volumetric feeder speed is referenced herein as a % of the maximum volumetric feeder speed (meaning the maximum critical speed of the volumetric feeder, beyond which increasing feeder speed would lead to decreasing volumetric throughput of polymer resin).

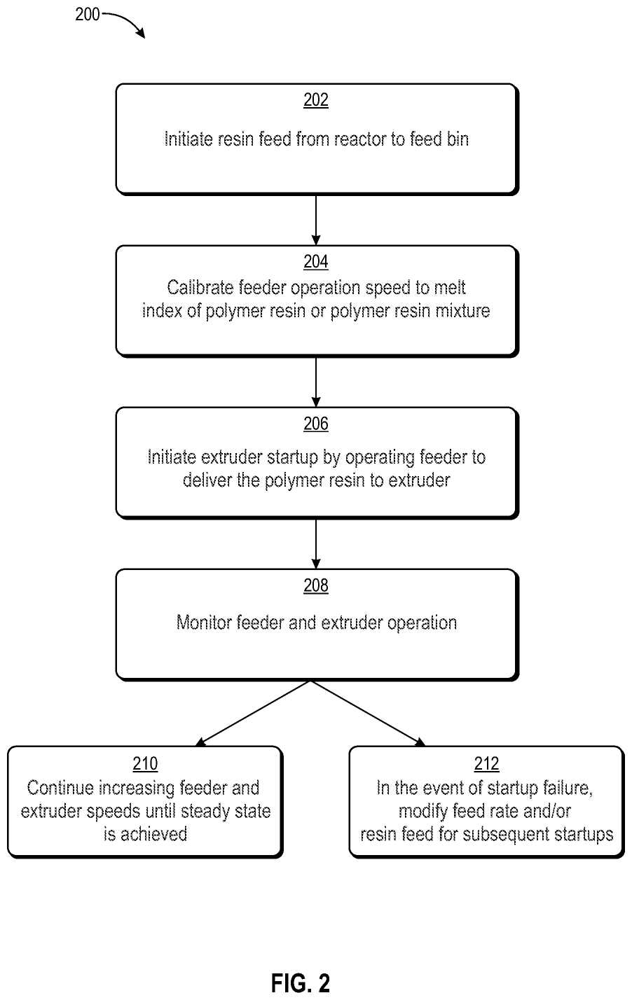

FIG. 2 is a flow diagram illustrating a method 200 of optimizing extruder startup in accordance with the present disclosure. At 202, prior to initiating extruder startup, a polymer resin (which may include a single polymer or a mixture of multiple polymers) is obtained from a reactor or other source and stored within a feedbin that dispenses to an extruder by way of a volumetric feeder having a controllable feed rate. At 204, the volumetric feeder speed may be calibrated to the MI of the polymer resin; that is, a calibrated feeder speed is determined based at least in part upon the MI of the polymer resin. In some cases, methods may include determining the MI of the polymer resin; although the MI in many cases may have been determined previously, such as when sourced externally or determined during synthesis, or when the polymer resin is part of a long-running product with a known MI that can be used for purposes of calibration.

As a starting point for calibration according to various embodiments, the speed of the volumetric feeder can be set higher for a higher-MI polymer; and lower for a lower-MI Polymer. That is, methods may include calibrating a first feeder speed for the volumetric feeder, the first feeder speed being associated with a first polymer resin MI value; and calibrating a second feeder speed for the volumetric feeder, the second feeder speed being associated with a second polymer resin MI value. The second feeder speed is higher than the first feeder speed; and concomitantly, the second polymer resin MI value is greater than the first polymer resin MI value. More particularly, the first polymer resin MI value can be less than 10 g/10 min, such as less than 9 g/10 min, or less than 8 g/10 min, such as within the range from a low end 0.1, 0.5, or 1 g/10 min, to a high end of 4, 5, 6, or 7 g/10 min; and the second polymer resin MI value can be 10 g/10 min or greater, such as within the range from a low of 10, 13, 14, or 15 g/10 min to a high of 15, 17, 20, 22, 25, 30, 35, or 40 g/10 min (with ranges from any of the foregoing low ends to any of the foregoing high ends contemplated herein). Also or instead, the first feeder speed may be within the range from 15, 17, or 20% to 23, 25, or 27% of the volumetric feeder max speed; and the second, higher, feeder speed can be within the range from 28, 29, or 30% to a 33, 34, or 35% of the volumetric feeder max speed. As noted, all MI values herein (unless otherwise noted) are determined according to ASTM D1238 at 230° C. with 2.16 kg load.

At 206, the extruder startup is initiated by operation of the volumetric feeder using the calibrated feeder speed. Startup is monitored at 208 by any appropriate control such as measuring one or more of feeder speed, melt pressure, die pressure, feeder pressure, barrel temperature, and the like. As startup progresses, feeder and extruder speeds may be increased (including by being increased above the calibrated feeder speed, intended as a start-up speed) by automated or manual means at 210 until steady state and production is achieved.

In the event of startup failure at 212, the startup conditions may be modified prior to attempting subsequent startups by analyzing the monitoring results at 208. In cases of insufficient extruder pressure or extruder overpressure, the selected feed rate of the volumetric feeder may be adjusted (increased, for insufficient pressure; or decreased, for cases of overpressure) by a suitable amount with respect to the failed startup feed rate, such as about 1%, about 5%, or about 10% of the volumetric feeder max speed, prior to attempting subsequent startups following an extruder shutdown.

The polymer resin feed may also be modified such that the observed MI is compatible with the selected feed rate by a number of methods, including changing resin grade or combining the initial polymer resin feed with a percentage of a second polymer resin of another grade. For example, a low MI polymer resin feed that is incompatible with a selected feed rate may be combined with a percentage of a second polymer resin having a higher MI to increase the observed MI of the mixture and decrease the likelihood of startup failure. Methods may include adding a second polymer resin at a percent by weight (wt %) of the resin mixture of about 5 wt % or less, about 10 wt % or less, about 20 wt % or less, or about 25 wt % or less (e.g., within ranges from greater than 0 wt %, such as within a range from 0.1 wt % to any of the foregoing wt % s), and repeating the method.

Resin feed MI may also be modified through the addition of various additives such as flow aids, lubricants, solvents, and the like. Additives can be combined with a polymer resin or mixture at a percent by weight (wt %) of the resin mixture from about greater than 0 to about 50%, from about 0.001% to about 45%, from about 1% to about 30%, or from about 1% to about 25%, prior to attempting subsequent startups following an extruder shutdown.

Methods herein may also be applicable to modifying volumetric feeder speed to accommodate different grades of polymer having different MI. For instance, as a starting point, a first polymer resin having a first MI is directed to the extruder by a volumetric feeder having a first feed speed; and then a second polymer resin having second MI higher than the first is directed to the extruder by the volumetric feeder having a second, higher, feed speed. In particular, the first MI can be less than 10 g/10 min, such as within a range from a low of any one of 0.1, 0.2, 0.3, 0.4, 0.5, 1, 2, or 3 g/10 min to a high of any one of 4, 5, 6, 7, 8, 9, 9.5, or 9.9 g/10 min; and the second MI can be 10 g/10 min or greater, such as from about 10, 11, 12, 13, 14 or 15 g/10 min to about 20, 21, 22, 23, 24 or 25 g/10 min (with ranges from any foregoing low ends to any foregoing high ends contemplated herein). Further, the first feed speed can range from about 20% to about 25% of the volumetric feeder max speed, while the second feed speed can range from about 30% to about 35% of the volumetric feeder max speed. Thus, as a more particular example, methods can include: directing a first polymer resin with MI of less than 10 g/10 min to an extruder by a volumetric feeder having a first feed speed; and directing a second polymer resin with MI of 10 g/10 min or greater to the extruder by the volumetric feeder at a second feed speed higher than the first feed speed. The first feed speed can range, e.g., from about 20% to about 25% of the volumetric feeder max speed; and the second feed speed can range, e.g., from about 30% to about 35% of the volumetric feeder max speed. The method may be performed in any order (e.g., the first polymer can be directed to the extruder at a first time, and the second polymer directed to the extruder at a second time after the first time; or vice-versa).

### Polymer Resins

The type of polymer resin being extruded is not particularly limited and may include any thermoplastic and/or elastomer suitable for extrusion, and blends thereof. Examples of suitable polymer resins include one or more of polyolefins, such as low, intermediate, or high density polyethylene (including homopolyethylene and ethylene copolymers, such as copolymers of 80 wt % or more ethylene-derived units and 20 wt % or less of units derived from one or more C₃ to C₁₂ α-olefins, such as 1-butene, 1-hexene, and/or 1-octene; where the wt % are based on total mass of olefin-derived units in the copolymer). Further examples of polyolefins include polypropylene, polybutene-1, poly-3-methylbutene-1, poly-4-methylpentane-1, other copolymers of monoolefins with other olefins (mono or diolefins) or vinyl monomers such as ethylene-propylene copolymer or with one or more additional monomers, such as ethylene propylene diene monomer rubber, ethylene/butylene copolymer, ethylene/vinyl acetate copolymer, ethylene/ethyl acrylate copolymer, propylene/4-methylpentene-1 copolymer, and the like.

Other polymer resins may include thermoplastic elastomers such as the “block” copolyesters from terephthalate, 1,4-butanediol and poly(tetramethylene ether)glycol; polystyrene; polystyrene polyphenylene oxide blends; polyesters such as polyethylene terephtalate, poly 1,4-butylene terephthalate, poly 1,4-cyclohexyldim ethylene terephthalate, and poly 1,3-propylene terephtalate; polyamides such as nylon-6,6, nylon-6, nylon-12, nylon-11, and aromatic-aliphatic copolyamides; polycarbonates such as poly bisphenol-A carbonate; fluorinated polymers such as copolymers of tetrafluoroethylene and hexafluoropropylene, polyvinyl fluoride, copolymers of ethylene and vinylidene fluoride or vinyl fluoride; polysulfides such as poly p-phenylene sulfide; polyetherketones; polyetheretherketones; polyetherketoneketones; polyetherimides; acrylonitrile-1,3-butadinene-styrene copolymers; (meth)acrylic polymers such as polymethyl methacrylate; and chlorinated polymers such as polyvinyl chloride.

Polymer resins may also include extrudable elastomers, including natural rubber, polyisobutylene, butyl, chlorobutyl, polybutadiene, butadiene-styrene, ethylene-propylene, ethylene-propylene diene terpolymer elastomers and mixtures thereof with each other and with thermoplastic polymers. Blends or mixtures of any of the above suitable polymer resins are also within the scope of this disclosure.

Embodiments disclosed herein include:

A. Methods for startup of an extruder include (a) initiating feed of a polymer resin to the extruder using a volumetric feeder such that, where the melt index of the polymer resin is less than 10 g/10 min (ASTM D1238 at 230° C., 2.16 kg), the volumetric feeder is operated at a speed ranging from about 20% to about 25% of the volumetric feeder max speed; or (b) initiating feed of a polymer resin to the extruder using the volumetric feeder such that, where the melt index of the polymer resin is 10 g/10 min or greater, the volumetric feeder is operated at a speed ranging from about 30% to about 35% of the volumetric feeder max speed.

B. Methods for startup of an extruder following a startup failure may include determining a melt index of a polymer resin, and determining a volumetric feeder speed used during the startup failure; and keeping the polymer resin constant and modifying the volumetric feeder speed by at least 5% of the volumetric feeder max speed; or keeping the volumetric feeder speed constant and modifying the polymer resin.

C. Methods may further include: (a) obtaining a polymer resin having a melt index; (b) determining a calibrated feeder speed for a volumetric feeder, based at least in part upon the melt index of the polymer resin; and (c) initiating extruder startup by operating the volumetric feeder to provide the polymer resin to the extruder at the calibrated feeder speed. The calibrated feeder speed can further be set within a range from about 20% to about 25% of the volumetric feeder max speed when the MI of the polymer resin is less than 10 g/10 min (ASTM D1238 at 230° C., 2.16 kg); or within a range from about 30% to about 35% of the volumetric feeder max speed when the MI of the polymer resin is 10 g/10 min or greater (ASTM D1238 at 230° C., 2.16 kg).

Embodiments A, B, and/or C may have one or more of the following additional elements in any combination:

Element 1: wherein the volumetric feeder is initiated at a speed ranging from 30% to 35% of max speed, where the melt index of the polymer resin is in a range of greater than 10 g/10 min to about 25 g/10 min.

Element 2a: Wherein the polymer resin comprises a polymer selected from the group consisting of polyethylene, polypropylene, polybutene-1, poly-3-methylbutene-1, poly-4-methylpentane-1, ethylene-propylene, ethylene propylene diene monomer rubber, ethylene/butylene copolymer, ethylene/vinyl acetate copolymer, ethylene/ethyl acrylate copolymer, propylene/4-methylpentene-1 copolymer, poly(tetramethylene ether)glycol, polystyrene, polystyrene polyphenylene oxide blends, polyesters, polyamides, aromatic-aliphatic copolyamides, polycarbonates, polyvinyl fluoride, copolymers of ethylene and vinylidene fluoride or vinyl fluoride, polysulfides, polyetherketones, polyetheretherketones, polyetherketoneketones, polyetherimides, acrylonitrile-1,3-butadinene-styrene copolymers, (meth)acrylic polymers, and chlorinated polymers.

Element 2b: wherein the polymer resin comprises or consists of a low density polyethylene (LDPE), an intermediate or medium density polyethylene (MDPE), or a high density polyethylene (HDPE). The low density polyethylene may in particular be a linear low density polyethylene (LLDPE), such as a Ziegler-Natta or metallocene-catalyzed LLDPE.

Element 2c: wherein the polymer resin comprises or consists of an ethylene homopolymer or ethylene copolymer.

Element 2d: wherein the polymer resin comprises or consists of a copolymer of 80 wt % or more ethylene-derived units and 20 wt % or less of units derived from one or more C₃ to C₁₂ α-olefins (such as 1-butene, 1-hexene, and 1-octene), said wt % s based upon total mass of olefin-derived units in the polymer resin.

Element 3: wherein the polymer resin comprises or consists of a blend of two or more polymer resins.

Element 4: wherein the volumetric feeder is selected from rotary feeders, screw feeders, vibratory feeders, or belted feeders.

Element 5: wherein the volumetric feeder is a rotary feeder.

Element 6: the methods further comprising modifying (increasing or decreasing) the speed of the volumetric feeder by 5% and repeating the method if the startup of the extruder fails.

Element 7: the methods further comprising modifying (increasing or decreasing) the speed of the volumetric feeder by 10% and repeating the method if the startup of the extruder fails.

Element 8: the methods further comprising modifying the polymer resin by combining the polymer resin with a second polymer resin having a different melt index and repeating the method if the startup of the extruder fails.

Element 9: the methods further comprising modifying the polymer resin by combining the polymer resin with a second polymer resin at a percent by weight (wt %) of about 10 wt % or less.

Element 10: the methods further comprising modifying the polymer resin by combining the polymer resin with an additive selected from a flow aid, lubricant, or solvent, and repeating the method if the startup of the extruder fails.

Element 11: the methods further comprising modifying the polymer resin by combining the polymer resin with an additive selected from a flow aid, lubricant, or solvent at a percent by weight (wt %) of about 1% to about 25%.

By way of non-limiting example, exemplary combinations applicable to A, B and C include, but are not limited to, 1 and any one or more of 2 (including 2a and 2b) to 11; 2 and any one or more of 1 and 3 to 11; 3 and any one or more of 1 to 2 and 4 to 11; 4 and any one or more of 1 to 3 and 5 to 11; 5 and any one or more of 1 to 4 and 6 to 11; 6 and any one or more of 1 to 5 and 7 to 11; 7 and any one or more of 1 to 6 and 8 to 11; 8 and any one or more of 1 to 7 and 9 to 10; and 9 and any one or more of 1 to 8 and 11; 10 and any one or more of 1 to 9 and 11; and 11 and any one or more of 1 to 10. In these exemplary combinations, any reference to element 2 includes elements 2a, 2b, 2c and 2d.

To facilitate a better understanding of the present disclosure, the following examples of preferred or representative embodiments are given. In no way should the following examples be read to limit, or to define, the scope of the invention

### Examples

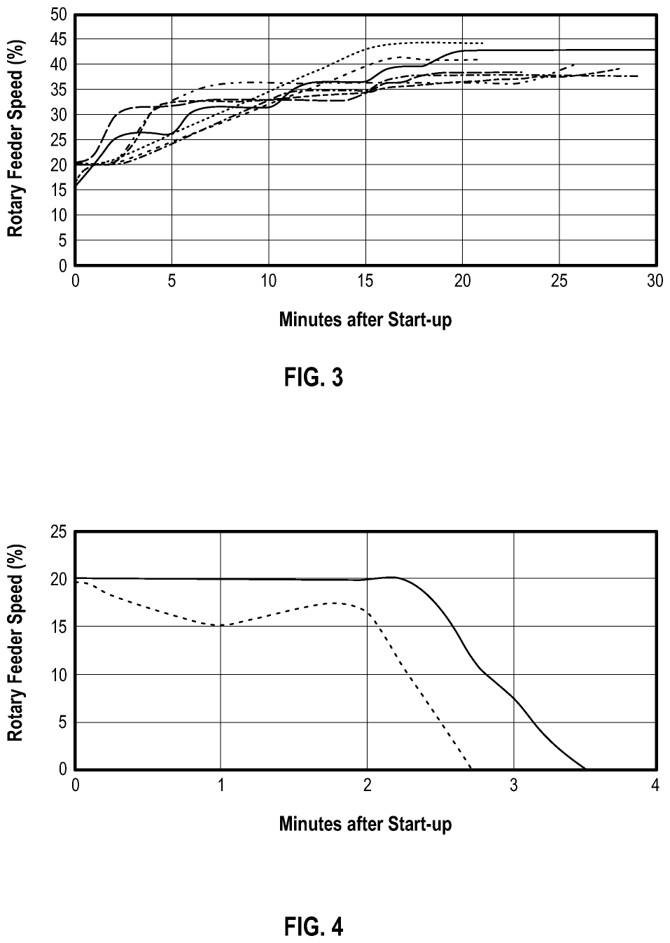

The following example employs an extruder system utilizing rotary feeders to control the pressure in the extruders by metering the flow of a low density polyethylene (LDPE) resin grade having a melt index of about 3. FIG. 3 displays trends of the rotary feeder's (RF's) speed (in terms of % of max feeder speed) during each of seven start-ups (each represented in FIG. 3 by a different line). Note that while the general trend is similar between various restarts, the initial speed of the rotary feeder starts around about 20% of maximum feeder speed. At the 20% rotary feed speed, failed restarts were observed using the same system and LDPE grade as shown in FIG. 4.

To account for this inconsistency and minimize the likelihood of extruder shutdown, the feed rate of the volumetric feeder for relatively high MI grades (≥10 MI, such as 10-20 MI in this example) was increased by 5% (additive, in terms of maximum volumetric feeder speed), from 25% of max feeder speed to 30% of max feeder speed. Similar results were observed for low MI grades (<10 MI, such as 3-5 MI in this example) operating at 20% feed rate; an increase of 5% (to 25% of max feeder speed) reduced the failed startup rate. With the updated feeder starting speeds, yearly startup failures in a commercial facility may be substantially reduced (e.g., 20-30 fewer extruder startup failures), which can lead to substantially fewer production losses per year. The adjustments are summarized in Table 1.

TABLE 1
Rotary Feeder Speed Adjustment

| Grade | Previous speed | New speed |
|---|---|---|
| 3-5 MI | 20% | 25% |
| 10-20 MI | 25% | 30% |

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

What is claimed is:

1. A method for the startup of an extruder, comprising:
initiating feed of a polymer resin to the extruder using a volumetric feeder such that, where the melt index of the polymer resin is less than 10 g/10 min (ASTM D1238 at 230° C., 2.16 kg), the volumetric feeder is operated at a first volumetric feeder speed; or
initiating feed of a polymer resin to the extruder using the volumetric feeder such that, where the melt index of the polymer resin is 10 g/10 min or greater, the volumetric feeder is operated at a second volumetric feeder speed greater than the first volumetric feeder speed.

2. The method of claim 1, wherein the first volumetric feeder speed is within the range from about 20% to about 25% of the volumetric feeder maximum speed; and the second volumetric feeder speed is within the range from about 30% to about 35% of the volumetric feeder maximum speed.

3. The method of claim 1, wherein, when the MI of the polymer resin is in a range from 10 to about 25 g/10 min, the volumetric feeder is operated at a speed ranging from 30% to 35% of max feeder speed during initiation of the feed of the polymer resin to the extruder.

4. The method of claim 1, wherein the polymer resin comprises a polymer selected from the group consisting of polyethylene, polypropylene, polybutene-1, poly-3-methylbutene-1, poly-4-methylpentane-1, ethylene-propylene, ethylene propylene diene monomer rubber, ethylene/butylene copolymer, ethylene/vinyl acetate copolymer, ethylene/ethyl acrylate copolymer, propylene/4-methylpentene-1 copolymer, poly(tetramethylene ether)glycol, polystyrene, polystyrene polyphenylene oxide blends, polyesters, polyamides, aromatic-aliphatic copolyamides, polycarbonates, polyvinyl fluoride, copolymers of ethylene and vinylidene fluoride or vinyl fluoride, polysulfides, polyetherketones, polyetheretherketones, polyetherketoneketones, polyetherimides, acrylonitrile-1,3-butadinene-styrene copolymers, (meth)acrylic polymers, and chlorinated polymers.

5. The method of claim 4, wherein the polymer resin comprises an ethylene homopolymer or copolymer comprising 80 wt % or more units derived from ethylene and 20 wt % or less of units derived from a C₃ to C₁₂ α-olefin.

6. The method of claim 1, wherein the polymer resin comprises a blend of two or more polymer resins.

7. The method of claim 1, wherein the volumetric feeder is selected from rotary feeders, screw feeders, vibratory feeders, or belted feeders.

8. The method of claim 1, further comprising modifying the speed of the volumetric feeder by 5% and repeating the method if the startup of the extruder fails.

9. The method of claim 1, comprising modifying the polymer resin by combining the polymer resin with a second polymer resin having a different melt index and repeating the method if the startup of the extruder fails.

10. The method of claim 1, further comprising modifying the polymer resin by combining the polymer resin with an additive selected from a flow aid, lubricant, or solvent, and repeating the method if the startup of the extruder fails.

11. A method for startup of an extruder following a startup failure for feeding a polymer resin to the extruder, comprising:
determining a melt index of the polymer resin and determining a volumetric feeder speed used during the startup failure; and
(a) keeping the polymer resin constant and modifying the volumetric feeder speed by at least 5% of the volumetric feeder max speed; or
(b) keeping the volumetric feeder speed constant and modifying the polymer resin.

12. The method of claim 11, wherein (b) the polymer resin is modified, and modifying the polymer resin comprises one or both of (1) combining the polymer resin with a second polymer resin having a different melt index or (2) combining the polymer resin with a flow aid, lubricant, or solvent.

13. The method of claim 11, wherein the feeder is selected from rotary feeders, screw feeders, vibratory feeders, or belted feeders.

14. The method of claim 13, wherein the feeder is a rotary feeder.

15. The method of claim 11, wherein the polymer resin comprises a polymer selected from a group consisting of polyethylene, polypropylene, polybutene-1, poly-3-methylbutene-1, poly-4-methylpentane-1, ethylene-propylene, ethylene propylene diene monomer rubber, ethylene/butylene copolymer, ethylene/vinyl acetate copolymer, ethylene/ethyl acrylate copolymer, propylene/4-methylpentene-1 copolymer, poly(tetramethylene ether)glycol, polystyrene, polystyrene polyphenylene oxide blends, polyesters, polyamides, aromatic-aliphatic copolyamides, polycarbonates, polyvinyl fluoride, copolymers of ethylene and vinylidene fluoride or vinyl fluoride, polysulfides, polyetherketones, polyetheretherketones, polyetherketoneketones, polyetherimides, acrylonitrile-1,3-butadinene-styrene copolymers, (meth)acrylic polymers, and chlorinated polymers.

16. The method of claim 15, wherein the polymer resin comprises an ethylene homopolymer or copolymer comprising 80 wt % or more units derived from ethylene and 20 wt % or less of units derived from a C₃ to C₁₂ α-olefin.

17. The method of claim 11, wherein the polymer resin comprises a blend of two or more polymer resins.

18. A method comprising:
(a) obtaining a polymer resin having a melt index (MI);
(b) determining a calibrated feeder speed for feeding the polymer resin to an extruder via a volumetric feeder, the calibrated feeder speed based at least in part upon the melt index of the polymer resin; and
(c) initiating startup of the extruder by operating the volumetric feeder to provide the polymer resin to the extruder at the calibrated feeder speed;
wherein the calibrated feeder speed is set to a first volumetric feeder speed when the MI of the polymer resin is less than 10 g/10 min (ASTM D1238 at 230° C., 2.16 kg); and is set to a second volumetric feeder speed greater than the first volumetric feeder speed when the MI of the polymer resin is 10 g/10 min or greater (ASTM D1238 at 230° C., 2.16 kg).

19. The method of claim 18, wherein the first volumetric feeder speed is within the range from about 20% to about 25% of the volumetric feeder maximum speed; and the second volumetric feeder speed is within the range from about 30% to about 35% of the volumetric feeder maximum speed.

20. The method of claim 18, wherein the polymer resin comprises a polymer selected from a group consisting of polyethylene, polypropylene, polybutene-1, poly-3-methylbutene-1, poly-4-methylpentane-1, ethylene-propylene, ethylene propylene diene monomer rubber, ethylene/butylene copolymer, ethylene/vinyl acetate copolymer, ethylene/ethyl acrylate copolymer, propylene/4-methylpentene-1 copolymer, poly(tetramethylene ether)glycol, polystyrene, polystyrene polyphenylene oxide blends, polyesters, polyamides, aromatic-aliphatic copolyamides, polycarbonates, polyvinyl fluoride, copolymers of ethylene and vinylidene fluoride or vinyl fluoride, polysulfides, polyetherketones, polyetheretherketones, polyetherketoneketones, polyetherimides, acrylonitrile-1,3-butadinene-styrene copolymers, (meth)acrylic polymers, and chlorinated polymers.
